(19) United States
(12) Patent Application Publication
(10) Pub. No.: US 2025/0018344 A1
(43) Pub. Date: Jan. 16, 2025

(54) HYDROPHILIC MODIFIED POLYMER MEMBRANE AND FABRICATION METHOD THEREFOR

(71) Applicant: Pukyong National University Industry-University Cooperation Foundation, Busan (KR)

(72) Inventors: Kie Yong CHO, Busan (KR); Jae Won PARK, Busan (KR); Young Je KWON, Busan (KR); Min Young SON, Busan (KR); Ji Woo BAE, Busan (KR)

(73) Assignee: Pukyong National University Industry-University Cooperation Foundation, Busan (KR)

(21) Appl. No.: 18/764,413

(22) Filed: Jul. 5, 2024

(30) Foreign Application Priority Data
Jul. 11, 2023 (KR) 10-2023-0089503

(51) Int. Cl. B01D 67/00; B01D 69/02; B01D 69/10; B01D 71/34; B01D 71/60

(52) U.S. Cl. CPC B01D 67/0006; B01D 67/0088; B01D 67/0095; B01D 69/02; B01D 69/107; B01D 71/34; B01D 71/60; B01D 71/601; B01D 2323/02; B01D 2325/36

(57) ABSTRACT

The present disclosure relates to a hydrophilic modified polymer membrane and a method for fabricating the same, and more specifically, to a polymer membrane dip-coated with double bond-containing PVDF (DPVDF) and modified to be hydrophilic by reaction with a polymer or monomer containing an amine group, and a method of fabricating the same. The polymer membrane of the present disclosure is fabricated by physically coating a porous polymer substrate by dip coating with DPVDF, and then chemically modifying the surface of the dip-coated substrate to be hydrophilic using a polymer or monomer containing an amine group. That is, the polymer membrane is fabricated by performing both physical coating and chemical coating so that the dissolution of inorganic particles in the membrane can be further suppressed.

### CROSS-REFERENCE TO PRIOR APPLICATION

This Application claims priority Patent to Korean Application No. 10-2023-0089503 (filed on Jul. 11, 2023), which is hereby incorporated by reference in its entirety.

### BACKGROUND

The present disclosure relates to a hydrophilic modified polymer membrane and a method for fabricating the same, and more specifically, to a polymer membrane dip-coated with double bond-containing PVDF (DPVDF) and modified to be hydrophilic by reaction with a polymer or monomer containing an amine group, and a method of fabricating the same.

Polymer membranes are used in various fields, including water treatment, protein purification processes for drug development, virus filters, seawater desalination, industrial wastewater purification facilities, and bacterial isolation processes in the food industry. Currently, in South Korea, most of the polymer membranes used in membrane processes are imported from foreign countries, and thus many manufacturers rely on foreign companies.

Materials used in polymer membranes include polyvinylidene fluoride (PVDF), polysulfone (PSF), polypropylene (PP), etc. Since most of the materials mainly used in the polymer membranes are hydrophobic in nature, they have a problem in that hydrophobic contaminants such as bacteria, viruses, proteins, and emulsifiers are adsorbed to the membrane surface, blocking membrane pores, thus shortening the lifespan of the membrane. Accordingly, it is desirable for the membrane to be hydrophilic in nature. However, polymer membranes are made of hydrophilic polymers, a problem arises if the membrane pores are blocked by coating, or the hydrophilic polymers may dissolve out in the water.

To overcome this problem, it is desirable that a membrane made of hydrophobic material be modified to become hydrophilic so that the adsorption of the above-described contaminants is prevented to the greatest possible extent. Conventional methods of modifying membranes to be hydrophilic include methods of using hydrophilic polymers or inorganic particles as an additive. However, the method of adding hydrophilic polymers has limitations in that the pore structure can be changed and the polymer material in the membrane can escape. In addition, the method of using inorganic particles as an additive has limitations in that the membrane is unstable under acidic conditions and complete coating cannot be achieved.

To overcome the above-described problems and limitations of the prior art, there is an increasing need for studies on new methods for modifying polymer membranes to be hydrophilic.

### PRIOR ART DOCUMENTS

### Patent Documents

(Patent Document 0001) Korean Patent No. 10-1715229

### SUMMARY

The present disclosure has been made to solve the above-described problems occurring in the prior art, and an object of the present disclosure is to provide a polymer membrane dip-coated with double bond-containing PVDF (DPVDF) and then modified to be hydrophilic by reaction with a polymer or monomer containing an amine group.

Another object of the present disclosure is to provide a method of fabricating a polymer membrane by dip-coating a hydrophobic porous polymer substrate with double bond-containing PVDF (DPVDF), followed by hydrophilic modification by reaction with a polymer or monomer containing an amine group.

Objects to be achieved by the present disclosure are not limited to the objects mentioned above, and other objects not mentioned above can be clearly understood by those skilled in the art from the following description.

The present disclosure provides a polymer membrane comprising a porous polymer substrate and a coating layer formed on at least one surface of the porous polymer substrate, wherein the coating layer comprises: a double bond-containing PVDF (DPVDF); and a polymer containing at least one amine group, or a monomer containing at least one amine group.

In the present disclosure, the polymer membrane may be used for water treatment, a virus filter, a pretreatment system for a seawater desalination process, or a food purification system.

The present disclosure also provides a method for fabricating a polymer membrane, comprising steps of: dip-coating a porous polymer substrate with a double bond-containing PVDF (DPVDF); and modifying the dip-coated substrate to be hydrophilic by immersing the dip-coated substrate in a solution containing either a polymer containing at least one amine group or a monomer containing at least one amine group.

In the present disclosure, the method for fabricating the polymer membrane may further comprise drying and rinsing steps.

In the present disclosure, the porous polymer substrate may comprise at least one selected from the group consisting of polyvinylidene fluoride (PVDF), Polyvinylidene fluoride-hexafluoropropylene (PVDF-HFP), polysulfone (PSF), polypropylene (PP), polyethylene (PE), and cellulose acetate.

In the present disclosure, the polymer containing at least one amine group may be at least one polymer selected from the group consisting of Jeffamine D-230, linear polyethyleneimine, branched polyethyleneimine (BPEI), polyacrylamide, and polyethylene glycol diamine.

In the present disclosure, the monomer containing at least one amine group may be at least one monomer selected from the group consisting of Jeffamine EDR 148, ethylenediamine (EDA), triethylenetetramine (TETA), hexamethylenediamine (HMDA), 1,3-diaminopropane, and diethylenetriamine (DETA).

In the present disclosure, the step of dip-coating the porous polymer substrate with the double bond-containing PVDF (DPVDF) may be a step of dip-coating the porous polymer substrate by immersion in a solution containing the DPVDF, wherein the solution containing the DPVDF may be a solution obtained by adding the DPVDF at a concentration of 0.03 to 0.3 wt % to a mixed solvent of acetone and ethanol mixed at a weight ratio of 0.8 to 3:1.

In the present disclosure, the solution containing either the polymer containing at least one amine group or the monomer containing at least one amine group may be a solution containing branched polyethyleneimine (BPEI) at a concentration of 0.6 to 0.9 M.

The present disclosure may provide a hydrophilic modified polymer membrane fabricated by dip-coating a hydrophobic porous polymer substrate with double bond-containing PVDF (DPVDF), followed by a reaction with a polymer or monomer containing an amine group.

The present disclosure may also provide a method of fabricating a hydrophilic polymer membrane by dip-coating a hydrophobic porous polymer substrate with double bond-containing PVDF (DPVDF), followed by a reaction with a polymer or monomer containing an amine group.

Effects of the present disclosure are not limited to the effects mentioned above, and other effects not mentioned above may be clearly understood by those skilled in the art from the appended claims.

### BRIEF DESCRIPTION OF THE DRAWINGS

FIG. 1 is a schematic diagram showing a method of fabricating a hydrophilic modified polymer membrane by dip-coating with DPVDF and then introducing BPEI.

FIG. 2 shows polymers and single molecules that may be used for hydrophilic modification of polymer membranes in the present disclosure.

FIG. 3 is a schematic diagram showing a method of fabricating a hydrophilic modified polymer membrane by dip-coating with DPVDF and then introducing BPEI.

FIG. 4 shows the results of evaluating the stability of membranes depending on the mixing ratio between acetone and ethanol in a DPVDF dip coating solution.

FIG. 5 shows the results of comparing the pore size and pore number of membranes depending on the concentration of DPVDF used for dip coating.

FIG. 6 shows the results of comparing the pore size of membranes depending on the concentration of DPVDF used for dip coating.

FIG. 7 shows the results of comparing the FT-IR peak, water contact angle, and water flux of membranes depending on the concentration of DPVDF used for dip coating.

FIG. 8 shows the results of comparing the FT-IR peak and water contact angle of membranes depending on the concentration of BPEI used for hydrophilic modification.

FIG. 9 shows the results of comparing the pore structure of membranes depending on the concentration of BPEI used for hydrophilic modification.

FIG. 10 shows the results of comparing the water flux of membranes depending on the concentration of BPEI used for hydrophilic modification.

FIG. 11 shows the results of analyzing the types of elements in the membrane after hydrophilic modification.

FIG. 12 shows the results of analyzing the BSA solution flux and protein adsorption performance of the hydrophilic modified membrane of the present disclosure.

FIG. 13 shows the results of analyzing the FT-IR peak and water contact angle of membranes depending on the concentration of Jeffamine D-230 used for hydrophilic modification.

FIG. 14 shows the results of analyzing the FT-IR peak and water contact angle of membranes depending on the type of monomer used for hydrophilic modification.

FIG. 15 shows the viral clearance effect of the hydrophilic modified membrane of the present disclosure.

### DETAILED DESCRIPTION

Terms used in the present specification are currently widely used general terms selected in consideration of their functions in the present disclosure, but they may change depending on the intents of those skilled in the art, precedents, or the advents of new technology. Additionally, in certain cases, there may be terms arbitrarily selected by the applicant, and in this case, their meanings are described in a corresponding description part of the present disclosure. Accordingly, terms used in the present disclosure should be defined based on the meaning of the term and the entire contents of the present disclosure, rather than the simple term name.

Unless otherwise defined, all terms used herein, including as technical or scientific terms, have the same meanings understood by those skilled in the art to which the present disclosure pertains. Terms such as those used in general and defined in dictionaries should be interpreted as having meanings identical to those specified in the context of related technology. Unless definitely defined in the present application, the terms should not be interpreted as having ideal or excessively formative meanings.

A numerical range includes numerical values defined in the range. Every maximum numerical limitation given throughout the present specification includes every lower numerical limitation, as if such lower numerical limitations were expressly written herein. Every minimum numerical limitation given throughout the present specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Hereinafter, the present disclosure will be described in detail.

### Polymer Membrane

The present disclosure provides a polymer membrane comprising a porous polymer substrate and a coating layer formed on at least one surface of the porous polymer substrate, wherein the coating layer comprises: a double bond-containing PVDF (DPVDF); and a polymer containing at least one amine group, or a monomer containing at least one amine group.

In the present disclosure, the porous polymer substrate may comprise at least one selected from the group consisting of polyvinylidene fluoride (PVDF), polyvinylidene fluoride-hexafluoropropylene (PVDF-HFP), polysulfone (PSF), polypropylene (PP), polyethylene (PE), and cellulose acetate. Preferably, the porous polymer substrate may comprise polyvinylidene fluoride (PVDF) or polyvinylidene fluoride-hexafluoropropylene (PVDF-HFP). More preferably, the porous polymer substrate may comprise polyvinylidene fluoride-hexafluoropropylene (PVDF-HFP).

In the present disclosure, the polymer containing at least one amine group may be at least one polymer selected from the group consisting of Jeffamine D-230, linear polyethyleneimine, branched polyethyleneimine (BPEI), polyacrylamide, and polyethylene glycol diamine. Preferably, the polymer may be at least one polymer selected from the group consisting of Jeffamine D-230, and branched polyethyleneimine (BPEI). More preferably, the polymer may be Jeffamine D-230, or branched polyethyleneimine (BPEI).

In the present disclosure, the monomer containing at least one amine group may be at least one monomer selected from the group consisting of Jeffamine EDR 148, ethylenediamine (EDA), triethylenetetramine (TETA), hexamethylenediamine (HMDA), 1,3-diaminopropane, and diethylenetriamine (DETA). Preferably, the monomer may be at least one monomer selected from the group consisting of ethylenediamine (EDA), triethylenetetramine (TETA), and diethylenetriamine (DETA). More preferably, the monomer may be ethylenediamine (EDA), triethylenetetramine (TETA), or diethylenetriamine (DETA).

According to one embodiment of the present disclosure, the polymer membrane may be used for water treatment, a virus filter, a pretreatment system for a seawater desalination process, or a food purification system.

### Method for Fabricating Polymer Membrane

The present disclosure also provides a method for fabricating a polymer membrane, comprising steps of: dip-coating a porous polymer substrate with a double bond-containing PVDF (DPVDF); and modifying the dip-coated substrate to be hydrophilic by immersing the dip-coated substrate in a solution containing either a polymer containing at least one amine group or a monomer containing at least one amine group.

The method for fabricating the polymer membrane may further comprise drying and rinsing steps. The drying and rinsing steps may comprise drying at a temperature of 70 to 90° C. for 5 to 15 minutes, followed by rinsing.

In the present disclosure, the porous polymer substrate may comprise at least one selected from the group consisting of polyvinylidene fluoride (PVDF), polyvinylidene fluoride-hexafluoropropylene (PVDF-HFP), polysulfone (PSF), polypropylene (PP), polyethylene (PE), and cellulose acetate. Preferably, the porous polymer substrate may comprise polyvinylidene fluoride (PVDF) or polyvinylidene fluoride-hexafluoropropylene (PVDF-HFP). More preferably, the porous polymer substrate may comprise polyvinylidene fluoride-hexafluoropropylene (PVDF-HFP).

In the method for fabricating the polymer membrane, the step of dip-coating the porous polymer substrate with the double bond-containing PVDF (DPVDF) may be a step of dip-coating the porous polymer substrate by immersion in a solution containing the DPVDF. The solution containing the DPVDF may be a solution obtained by adding the DPVDF at a concentration of 0.03 to 0.3 wt& to a mixed solvent of acetone and ethanol mixed at a weight ratio of 0.8 to 3:1. Preferably, the solution containing the DPVDF may be a solution obtained by adding the DPVDF at a concentration of 0.03 to 0.15 wt % to a mixed solvent of acetone and ethanol mixed at a weight ratio of 0.8 to 3:1. More preferably, the solution containing the DPVDF may be a solution obtained by adding the DPVDF at a concentration of 0.03 to 0.07 wt % to a mixed solvent of acetone and ethanol mixed at a weight ratio of 0.8 to 3:1.

In the step of dip-coating the porous polymer substrate

with the double bond-containing PVDF (DPVDF), the porous polymer substrate may be immersed in the solution containing the DPVDF at a temperature of 15 to 25° C. for 5 to 20 seconds.

The step of modifying the dip-coated substrate to be hydrophilic by immersing the dip-coated substrate in a solution containing either a polymer containing at least one amine group or a monomer containing at least one amine group may be a step of modifying the dip-coated substrate to be hydrophilic by immersing the dip-coated substrate in the solution containing either the polymer containing at least one amine group or the monomer containing at least one amine group to induce a Michael addition reaction between the DPVDF and the polymer or the monomer.

In the present disclosure, the polymer containing at least one amine group may be at least one polymer selected from the group consisting of Jeffamine D-230, linear polyethyleneimine, branched polyethyleneimine (BPEI), polyacrylamide, and polyethylene glycol diamine. Preferably, the polymer may be at least one polymer selected from the group consisting of Jeffamine D-230, and branched polyethyleneimine (BPEI). More preferably, the polymer may be Jeffamine D-230, or branched polyethyleneimine (BPEI).

In the present disclosure, the monomer containing at least one amine group may be at least one monomer selected from the group consisting of Jeffamine EDR 148, ethylenediamine (EDA), triethylenetetramine (TETA), hexamethylenediamine (HMDA), 1,3-diaminopropane, and diethylenetriamine (DETA). Preferably, the monomer may be at least one monomer selected from the group consisting of ethylenediamine (EDA), triethylenetetramine (TETA), and diethylenetriamine (DETA). More preferably, the monomer may be ethylenediamine (EDA), triethylenetetramine (TETA), or diethylenetriamine (DETA).

Preferably, the solution containing either the polymer containing at least one amine group or the monomer containing at least one amine group may be a solution obtained by adding branched polyethyleneimine (BPEI) to an ethanol solvent at a concentration of 0.4 to 1.2 M. More preferably, the solution may be a solution obtained by adding branched polyethyleneimine (BPEI) to an ethanol solvent at a concentration of 0.6 to 0.9 M.

The present disclosure may also provide a polymer membrane fabricated according to the above-described method for fabricating a polymer membrane.

The method for fabricating a polymer membrane according to the present disclosure may be a method of physically coating a porous polymer substrate by dip coating with DPVDF, and then chemically modifying the dip-coated substrate to be hydrophilic using a polymer or monomer containing an amine group. That is, it is a method in which both physical coating and chemical coating are performed so that the possibility of dissolution of the materials in the membrane can be further suppressed.

If a membrane is chemically modified to be hydrophilic using the polymer or monomer containing an amine group without the process of dip coating with DPVDF, inorganic particles may escape from the membrane during operation of the membrane and contaminate the purified solution.

However, according to the fabrication method of the present disclosure, which comprises dip-coating with DPVDF and then chemically modifying the membrane to be hydrophilic using the polymer or monomer containing an amine group, it is possible to increase the adhesion between the DPVDF and the polymer or monomer containing an amine group, thus reducing the possibility that inorganic particles within the separation membrane will escape from the membrane and contaminate the purified solution.

Hereinafter, examples of the present disclosure will be described in detail, but it is obvious that the present disclosure is not limited by the following examples.

### Example 1. Fabrication of Membrane Hydrophilically Modified With Branched Polyethyleneimine (BPEI)

### 1-1. Dip Coating With DPVDF

A PVDF-HFP membrane was fabricated based on non-solvent induced phase separation (NIPS). Next, a dip coating solution was prepared by adding 0.05 wt % of double bond-containing PVDF (DPVDF) to a 5:5 solvent mixture of acetone and ethanol. The PVDF-HFP membrane was dip-coated by immersion in the dip-coating solution for 10 seconds.

### 1-2. Hydrophilic Modification

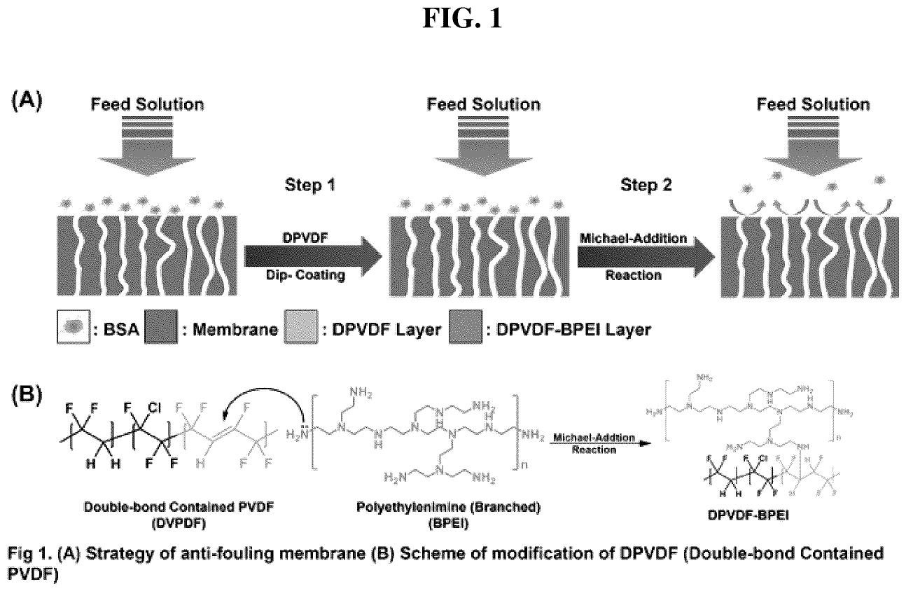

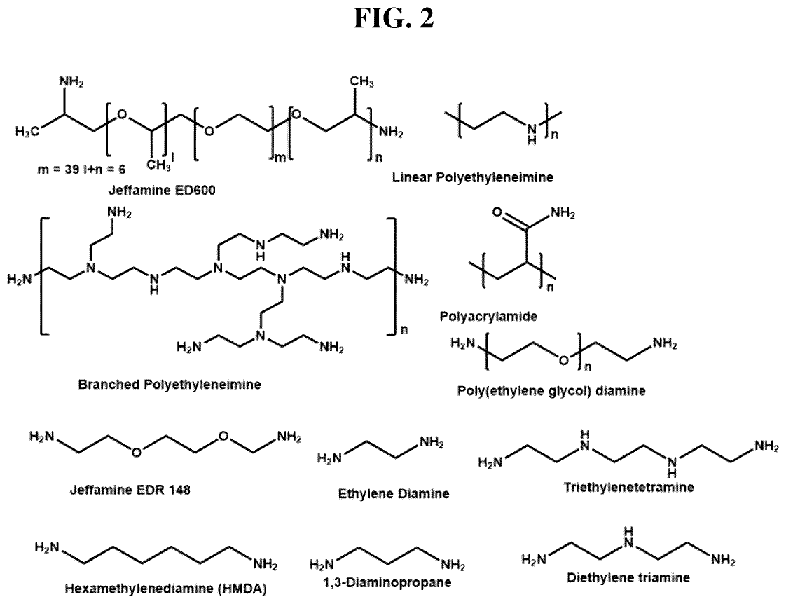

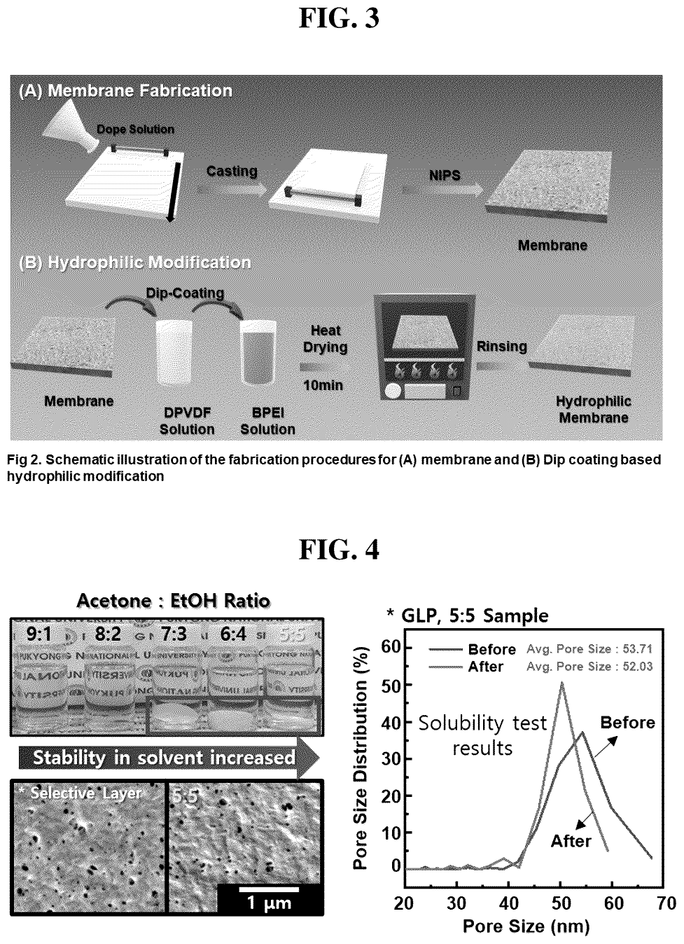

The membrane dip-coated in Example 1-1 was modified to be hydrophilic by reaction with branched polyethyleneimine (BPEI). First, a BPEI solution was prepared. The BPEI solution was prepared by dissolving BPEI in an ethanol solvent at a concentration of 0.75 M. The membrane dip-coated in Example 1-1 was immersed in the BPEI solution for 20 seconds and then dried at 80° C. for 10 minutes. During the immersion and drying processes, a Michael addition reaction between the DPVDF coating formed on the membrane and BPEI was induced. The membrane fabrication method described in Example 1 is schematically shown in FIGS. 1 and 3.

### Experimental Example 1. Analysis of Membrane Stability Depending on Ratio Between Solvents in DPVDF Dip Coating Solution

The solvent used to prepare the DPVDF dip coating solution in Example 1 was a 5:5 solvent mixture of acetone and ethanol. In Experimental Example 1, the stability of the membrane after dip coating was analyzed depending on the ratio between acetone and ethanol. Solvent mixtures were prepared by mixing acetone and ethanol at a ratio of 9:1, 8:2, 7:3, 6:4, or 5:5, and the PVDF-HFP membrane was coated by dipping in each of the solvent mixtures, obtained at different mixing ratios, at room temperature for 10 seconds.

The results of Experimental Example 1 are shown in FIG. 4.

As a result of Experimental Example 1, it was confirmed that the membrane melted and disappeared in a 9:1 or 8:2 solvent mixture of acetone and ethanol, but in a 7:3 or 5:5 solvent mixture of acetone and ethanol, the membrane was stable without being melting. In particular, the membrane was most stable in a 5:5 solvent mixture of acetone and ethanol.

Accordingly, the PVDF-HFP membrane was immersed for 30 minutes in a 5:5 solvent mixture of acetone and ethanol without DPVDF for 30 minutes, and then the pore structure was observed using an SEM microscope. Here, the SEM microscope used to observe the pore structure was TESCAN's model MIRA3 and was used at 50,000× magnification. Thereafter, the pore size was analyzed using a porometer (Porolux 1000). More specifically, the pore size was analyzed using a gas liquid porometry method, which analyzes the pore size using the fed flow while increasing the pressure from 0 to 300 psi. The results of the observation are shown in FIG. 4, and it was confirmed that the pore structure and size remained the same.

### Experimental Example 2. Analysis of Pore Structure of Membranes Depending on DPVDF Concentration Used in Dip Coating

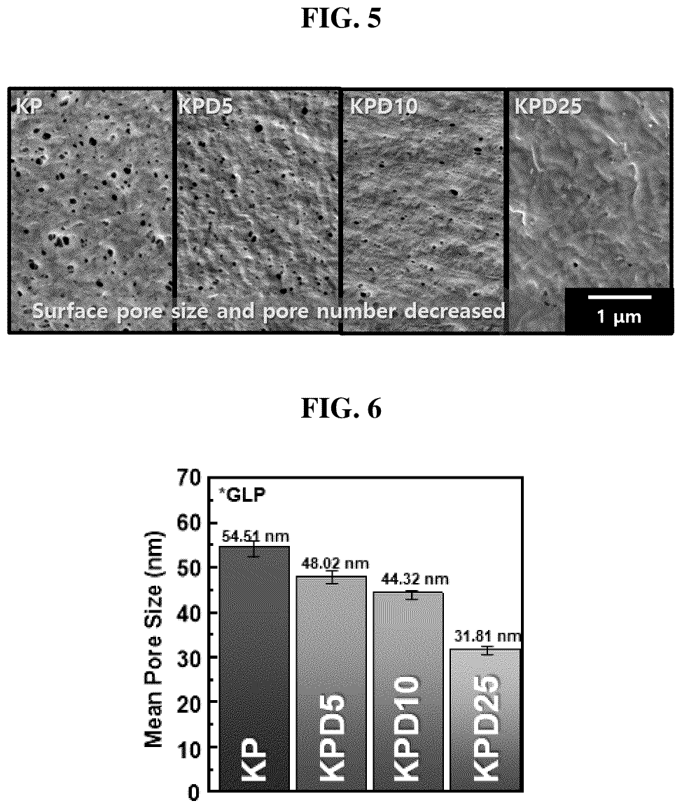

Experimental Example 2 was conducted to analyze the pore size and number of membranes depending on the DPVDF concentration used in dip coating. In Experimental Example 2, membranes dip-coated with DPVDF were fabricated in the same manner as Example 1-1, except that DPVDF was used at different concentrations of 0.05, 0.1 and 0.25 wt %. The pore size and pore number of the fabricated membranes using different concentrations of DPVDF were observed under an SEM microscope, and the results of the microscopic observation are shown in FIG. 5. In FIG. 5, the membrane not coated with DPVDF was named KP, and the membranes obtained using DPVDF concentrations of 0.05, 0.1 and 0.25 wt % were named KPD5, KPD10, and KPD25, respectively. As a result, it was confirmed that, as the DPVDF concentration increased, the pore size and pore number of the membrane decreased. In addition, the pore sizes of KP, KPD5, KPD10, and KPD25 were analyzed using a porometer (Porolux 1000), and the results of the analysis are shown graphically in FIG. 6. It was confirmed that the pore size of KP was 54.51 nm, the pore size of KPD5 was 48.02 nm, the pore size of KPD10 was 44.32 nm, and the pore size of KPD25 was 31.81 nm.

### Experimental Example 3. Analysis of Surface Property and Water Flux of Membranes Dip-Coated with DPVDF

Membranes were fabricated using DPVDF concentrations of 0.05, 0.1, and 0.25 wt %, respectively, in the same manner as in Experimental Example 2, and were named KPD5, KPD10, and KPD25, respectively, as in Experimental Example 2. Similarly, a membrane not coated with DPVDF was prepared and named KP.

The carbon-carbon double bond peak included in DPVDF in each of KP, KP5, KP10, and KP25 was analyzed by FT-IR. The FT-IR was performed used model iS10 model (Thermofisher). FT-IR measurements were performed in ATR mode using dried films.

In addition, the water contact angles of KP, KP5, KP10, and KP25 were analyzed. The water contact angle was measured using model Phoenix 300 (SEO), and was measured based on the contact angle between the membrane and the water droplet using 5 μl of a deionized water droplet according to the ASTM D5946 method.

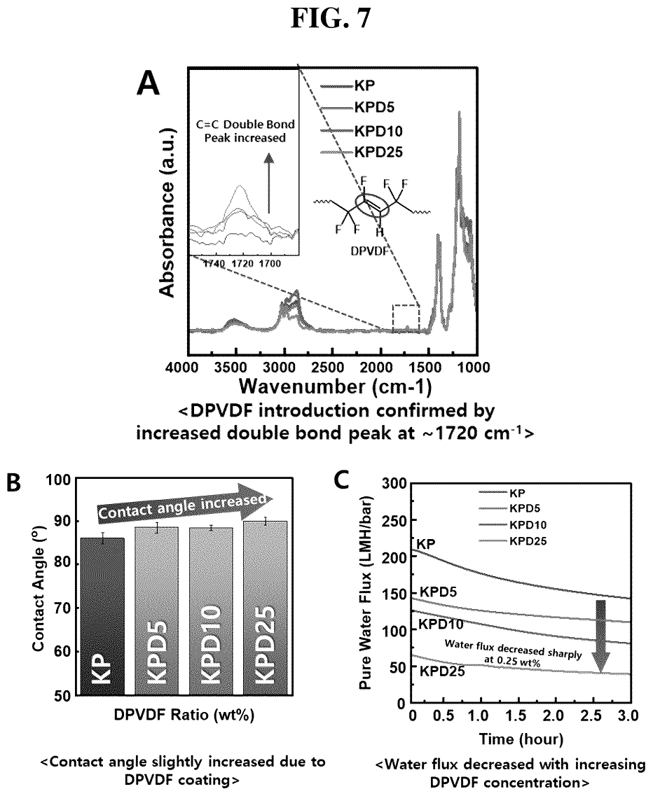

The water flux of each of KP, KP5, KP10, and KP25 was also analyzed. The water flux analysis was performed using a dead-end cell filtration system. More specifically, when a container containing a feed solution was pressurized with nitrogen gas, the liquid in the container flowed through the pipe into the dead-end cell. At this time, the liquid that flowed into the dead-end cell was filtered through the membrane located at the bottom of the dead-end cell, and the weight of the filtered solution was recorded using an electronic scale. Based on the recorded weight, the flux (LMH) was obtained, which means the volume of the permeate solution per unit area. The results of analyzing the carbon-carbon double bond peak are shown in FIG. 7, A, the results of analyzing the water contact angle are shown in FIG. 7, B, and the results of analyzing the water flux are shown in FIG. 7, C.

As a result of Experimental Example 3, it was confirmed that, as the DPVDF concentration used in dip coating increased, the carbon-carbon double bond peak (˜1720 cm⁻¹) in DPVDF increased (FIG. 7, A). In addition, as the DPVDF concentration increased, the roughness of the membrane surface increased and the water contact angle also increased (FIG. 7, B). In addition, as the DPVDF concentration increased, the water flux decreased. At a DPVDF concentration of 0.25 wt %, the water flux decreased sharply, and at a concentration of 0.05 wt %, the decrease in water flux was the smallest. Therefore, it is considered that the DPVDF concentration used in dip coating of the polymer membrane is most preferably 0.05 wt %.

### Experimental Example 4. FT-IR and Water Contact Angle Analysis Depending on Concentration of Branched Polyethyleneimine (BPEI)

Experimental Example 4 was conducted to analyze the FT-IR peak and water contact angle depending on the concentration of branched polyethyleneimine (BPEI) introduced to the membrane dip-coated with DPVDF.

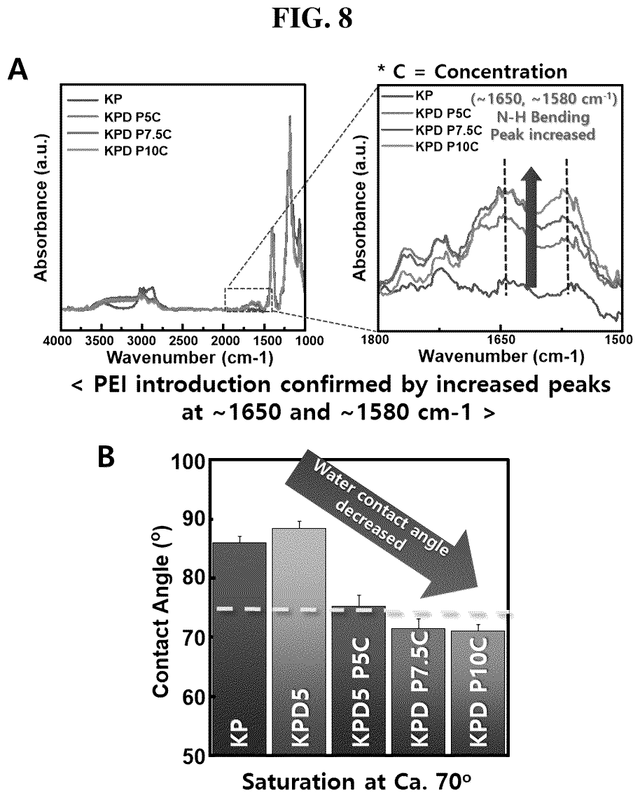

First, the PVDF-HFP membrane was coated with DPVDF in the same manner as in Example 1, and then modified to be hydrophilic by reaction with BPEI. However, for use in hydrophilic modification in Experimental Example 4, BPEI was dissolved in an ethanol solvent at varying concentrations of 0.5, 0.75, and 1 M. In Experimental Example 4, the membrane fabricated using 0.5 M of BPEI was named KPD-P5C, the membrane fabricated using 0.75 M of BPEI was named KPD-P7.5C, and the membrane fabricated using 1 M of BPEI named KPD-P10C. In addition, the membrane subjected only to DPVDF dip coating without BPEI introduction was named KPD, and the membrane subjected to neither BPEI introduction nor DPVDF dip coating was named KP. The results of analyzing the FT-IR peaks of KP, KPD, KPD P5C, KPD P7.5C, and KPD P10C are shown in FIG. 8, A, and the results of analyzing the water contact angles are shown in FIG. 8, B.

The FT-IR and water contact angle analysis in Experimental Example 4 were conducted in the same manner as in Experimental Example 3. However, in Experimental Example 4, a washing process was additionally performed using ethanol at 30° C. for 6 hours.

As a result of Experimental Example 4, it was confirmed that, as the BPEI concentration increased, the N—H bending peaks at ˜1,650 and ˜1,580 cm⁻¹ increased (FIG. 8, A). In addition, the water contact angle decreased as the BPEI concentration increased (FIG. 8, B).

### Experimental Example 5. Determination of Optimal Concentration of Branched Polyethyleneimine (BPEI) for Use in Polymer Membrane Fabrication

### 5-1. Analysis of Pore Structure of Membrane Depending on Concentration of Branched Polyethyleneimine (BPEI)

Experimental Example 5-1 was conducted to analyze the pore structures of membranes depending on the concentration of branched polyethyleneimine (BPEI) introduced to the membrane dip-coated with DPVDF. Membranes KP, KPD P5C, KPD P7.5C, and KPD P10C to which BPEI was introduced at different concentrations were fabricated in the same manner as in Experimental Example 4 above.

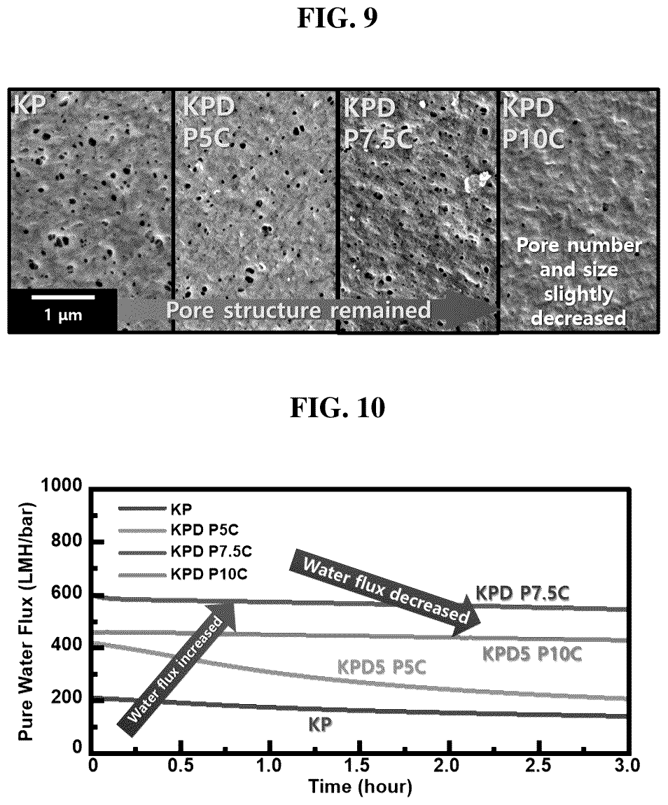

The pore structures of KP, KPD P5C, KPD P7.5C, and KPD P10C were observed using an SEM microscope in the same manner as in Experimental Example 1. The results of the observation are shown in FIG. 9.

As a result of Experimental Example 5-1, it was confirmed that, when BPEI was introduced at a concentration of 0.5 or 0.75 M, the pore structure was maintained, but when BPEI was introduced at a concentration of 1 M, the pore number and size decreased.

### 5-2. Analysis of Water Flux of Membrane Depending on Concentration of Branched Polyethyleneimine (BPEI)

Experimental Example 5-2 was conducted to analyze the

water flux of membranes depending on the concentration of branched polyethyleneimine (BPEI) introduced to the membrane dip-coated with DPVDF. Membranes KP, KPD P5C, KPD P7.5C, and KPD P10C to which BPEI was introduced at different concentrations were fabricated in the same manner as in Experimental Example 4 above.

Analysis of the water flux of KP, KPD P5C, KPD P7.5C, and KPD P10C was performed in the same manner as in Experimental Example 3, and the results of analyzing the water flux are shown in FIG. 10.

As a result of Experimental Example 5-2, it was confirmed that the water flux of the membrane (KPD P5C) to which BPEI was introduced at a concentration of 0.5 M was higher than that of the membrane (M) to which BPEI was not introduced, and the water flux of the membrane (KPD P7.5C) to which BPEI was introduced at a concentration of 0.75 M was the highest.

However, the water flux of the membrane (KPD P10C) to which BPEI was introduced at a concentration of 1 M was lower than that of KPD P5C (FIG. 10). Therefore, it is considered most desirable to introduce 0.75 M of BPEI in the fabrication of the polymer membrane of the present disclosure.

### Experimental Example 6. Elemental Analysis of Hydrophilic Modified Membrane

A polymer membrane was fabricated in the same manner as Example 1 above. More specifically, in the same manner as Example 1, the PVDF-HFP membrane was dip-coated with a dip coating solution containing 0.05 wt % of DPVDF in a 5:5 solvent mixture of acetone and ethanol, and then modified to be hydrophilic with a solution of 0.75 M BPEI in an ethanol solvent.

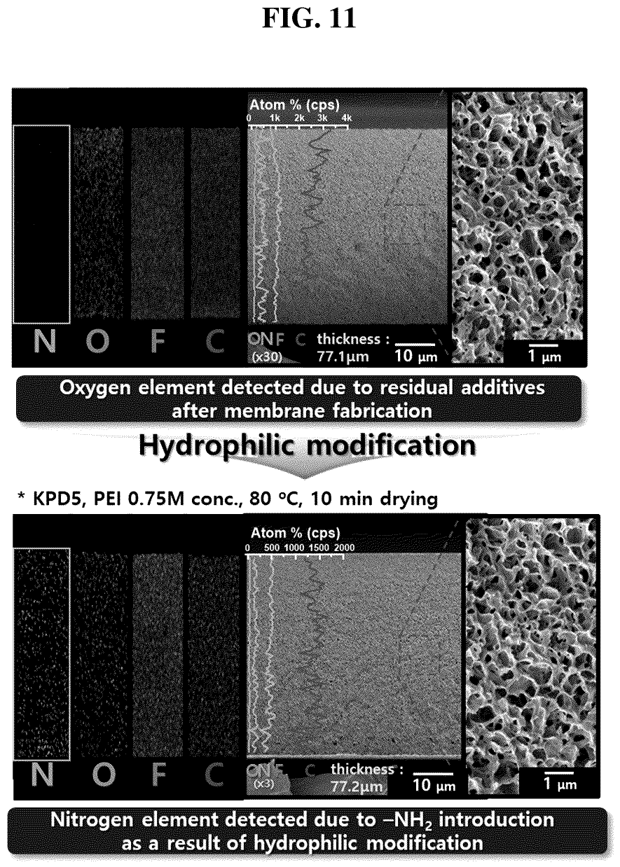

The resulting hydrophilic modified membrane was subjected to elemental analysis. In Experimental Example 6, elemental analysis was performed using energy dispersive spectrometer (EDS) mapping, and the results of Experimental Example 6 are shown in FIG. 11.

As a result of Experimental Example 6, it was confirmed that the nitrogen (N) element appeared evenly in the membrane after hydrophilic modification compared to the membrane before hydrophilic modification. In addition, even after hydrophilic modification, the pore structure of the cross-section of the membrane remained the same (FIG. 11).

### Experimental Example 7. Analysis of BSA Solution Flux and BSA Retention Rate of Hydrophilic Modified Membrane

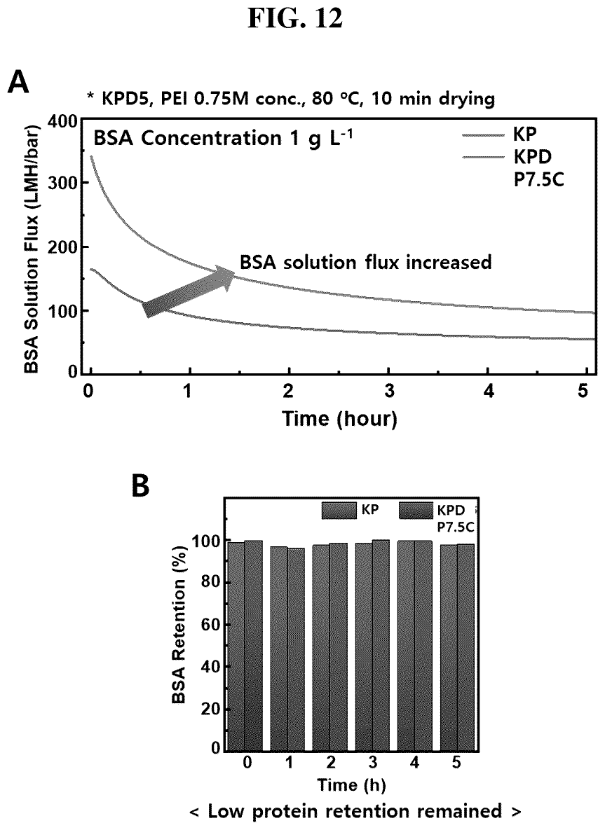

Experimental Example 7 was conducted to analyze the BSA solution flux and BSA retention rate of the polymer membrane fabricated in the same manner as Example 1. The method of analyzing the BSA solution flux in Experimental Example 7 was carried out in the same manner as in Experimental Example 3. However, although deionized water was used as the permeate solution in Experimental Example 3, a solution obtained by dissolving BSA in a PBS solution at a concentration of 1 g/L was used as the permeate solution in Experimental Example 7. All experimental conditions were the same as those other Experimental Example 3. The experimental results of Experimental Example 7 are shown in FIG. 12.

As a result of this Experimental Example 7, it was confirmed that the BSA solution flux of the membrane dip-coated with DPVDF and subjected to hydrophilic modification increased (FIG. 12, A), and the protein adsorption performance thereof was low (FIG. 12, B).

### Example 2. Fabrication of Polymer Membrane With Hydrophilically Modified With Jeffamine D-230

Example 2 was performed to fabricate a polymer membrane dip-coated with DPVDF and modified to be hydrophilic by reaction with Jeffamine D-230. In Example 2, a membrane dip-coated with DPVDF was fabricated in the same manner as Example 1-1.

The membrane dip-coated in Example 1-1 was modified to be hydrophilic by reaction with Jeffamine D-230. First, a solution of Jeffamine D-230 was prepared. The solution was prepared by dissolving Jeffamine D-230 in an ethanol solvent at a concentration of 0.80 M. The membrane dip-coated in Example 1-1 was immersed in the Jeffamine D-230 solution for 20 seconds and then dried at 80° C. for 10 minutes. During the immersion and drying processes, a Michael addition reaction between the DPVDF coating formed on the membrane and Jeffamine D-230 was induced.

### Experimental Example 8. Analysis of FT-IR Peak and Water Contact Angle Depending on Concentration of Jeffamine D-230

Experimental Example 8 was conducted to analyze the FT-IR peak and water contact angle of membranes depending on the concentration of Jeffamine D-230. First, membranes were fabricated by dip coating with DPVDF in the same manner as Example 2 and then modification with Jeffamine D-230. However, Jeffamine D-230 in ethanol was dissolved at varying concentrations of 0.20, 0.50, and 0.80 M and introduced to the membrane. Other fabrication conditions were the same as those in Example 2 above. The membrane fabricated using 0.20 M of Jeffamine D-230 was named DPVDF-J20, the membrane fabricated using 0.50 M of Jeffamine D-230 was named DPVDF-J50, and the membrane fabricated using 0.80 M of Jeffamine D-230 was named DPVDF-J80.

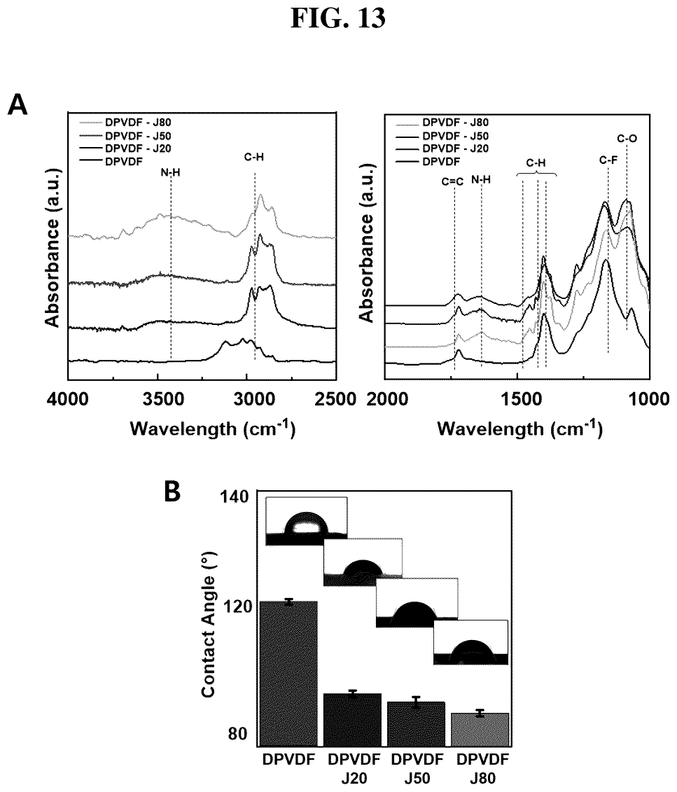

The FT-IR peaks of DPVDF-J20, DPVDF-J50, and DPVDF-J80 were analyzed in the same manner as in Experimental Example 3, and the results of analyzing the FT-IR peaks in Experimental Example 8 are shown in FIG. 13, A. The results of analyzing the water contact angles of the membranes are shown in FIG. 13, B.

As a result of Experimental Example 8, it can be confirmed through the FT-IR peaks that Jeffamine D-230 was introduced. More specifically, the N—H stretching, N—H bending, and C—O stretching peaks increased, suggesting that Jeffamine D-230 was introduced (FIG. 13, A). In addition, it was confirmed that, as the concentration of Jeffamine D-230 increased, the water contact angle decreased, indicating that the membrane was modified to be hydrophilic (FIG. 13, B).

### Example 3. Fabrication of Polymer Membrane Hydrophilically Modified With Ethylenediamine (EDA)

Example 3 was performed to fabricate a polymer membrane dip-coated with DPVDF and modified to be hydrophilic by reaction with ethylenediamine (EDA). In Example 3, a membrane dip-coated with DPVDF was fabricated in the same manner as in Example 1-1.

The dip-coated membrane fabricated in Example 1-1 was modified to be hydrophilic by reaction with ethylenediamine (EDA). First, an ethylene diamine solution was prepared. The solution was prepared by dissolving ethylene diamine in an ethanol solvent at a concentration of 0.75 M. The membrane dip-coated in Example 1-1 was immersed in the ethylene diamine solution for 20 seconds and then dried at 80° C. for 10 minutes. During the immersion and drying processes, a Michael addition reaction between the DPVDF coating formed on the membrane and ethylenediamine was induced.

### Example 4. Fabrication of Polymer Membrane Hydrophilically Modified With Triethylenetetramine (TETA)

Example 4 was performed to fabricate a polymer membrane dip-coated with DPVDF and modified to be hydrophilic by reaction with triethylenetetramine (TETA). In Example 4, a membrane dip-coated with DPVDF was fabricated in the same manner as in Example 1-1.

The dip-coated membrane fabricated in Example 1-1 was modified to be hydrophilic by reaction with triethylenetetramine (TETA). First, a triethylenetetramine solution was prepared. The solution was prepared by dissolving triethylenetetramine in an ethanol solvent at a concentration of 0.75 M. The membrane dip-coated in Example 1-1 was immersed in the triethylenetetramine solution for 20 seconds and then dried at 80° C. for 10 minutes. During the immersion and drying processes, a Michael addition reaction between the DPVDF coating formed on the membrane and triethylenetetramine was induced.

### Example 5. Fabrication of Polymer Membrane Hydrophilically Modified With Diethylenetriamine (DETA)

Example 5 was performed to fabricate a polymer membrane dip-coated with DPVDF and modified to be hydrophilic by reaction with diethylenetriamine (DETA). In Example 5, a membrane dip-coated with DPVDF was fabricated in the same manner as in Example 1-1.

The dip-coated membrane fabricated in Example 1-1 was modified to be hydrophilic by reaction with diethylenetriamine (DETA). First, a diethylenetriamine solution was prepared. The solution was prepared by dissolving diethylenetriamine in an ethanol solvent at a concentration of 0.75 M. The membrane dip-coated in Example 1-1 was immersed in the diethylenetriamine solution for 20 seconds and then dried at 80° C. for 10 minutes. During the immersion and drying processes, a Michael addition reaction between the DPVDF coating formed on the membrane and diethylenetriamine was induced.

### Experimental Example 9. Analysis of FT-IR Peak and Water Contact Angle Depending on Type of Monomer for Hydrophilic Modification

Experimental Example 9 was conducted to analyze the FT-IR peak and water contact angle of membranes depending on the type of monomer used for hydrophilic modification. Ethylenediamine (EDA), triethylenetetramine (TETA), and diethylenetriamine (DETA) were used as the monomers. Membranes were fabricated in the same manner as Examples 3 to 5 above. The membrane fabricated in Example 3 was named DPVDF-EDA, the membrane fabricated in Example 4 was named DPVDF-TETA, and the membrane fabricated in Example 5 was named DPVDF-DETA.

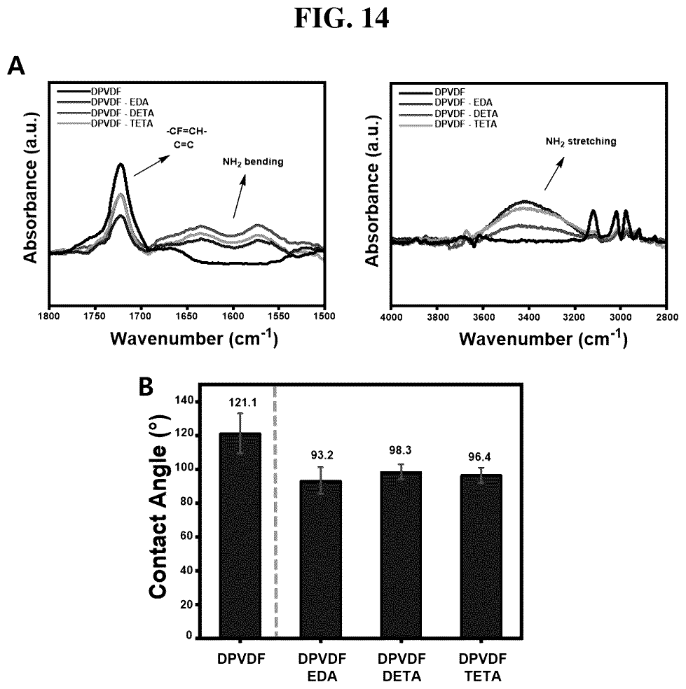

The FT-IR peaks and water contact angles of DPVDF-EDA, DPVDF-TETA, and DPVDF-DETA were analyzed in the same manner as in Experimental Example 3. The results of analyzing the FT-IR peaks in Experimental Example 9 are shown in FIG. 14, A, and the results of analyzing the water contact angles are shown in FIG. 14, B.

As a result of Experimental Example 9, it can be confirmed through the FT-IR peaks that EDA, TETA, and DETA were each introduced. Since the functional group of each of EDA, TETA, and DETA reacts with the C═C bond of DPVDF, it was observed that as the introduction of the functional group progressed, the C═C double bond peak in each of DPVDF-EDA, DPVDF-TETA, and DPVDF-DETA tended to decrease compared to that in the control DPVDF. In addition, the NH: bending peaks (1,640 and 1,580 cm⁻¹) and NH₂ stretching peak (3,400-3,300 cm⁻¹) were observed to increase as the amine group was introduced (FIG. 14, A). In addition, it was confirmed that the water contact angles of DPVDF-EDA, DPVDF-TETA, and DPVDF-DETA decreased compared to that of DPVDF. More specifically, it was confirmed that the water contact angle of DPVDF was 121.1°, the water contact angle of DPVDF-EDA was 93.2°, the water contact angle of DPVDF-DETA was 98.3°, and the water contact angle of DPVDF-TETA was 96.4° (FIG. 14, B).

### Experimental Example 10. Viral Clearance Effect of Hydrophilic Modified Polymer Membrane

Experimental Example 10 was conducted to evaluate the viral clearance effect of the hydrophilic modified polymer membrane. The membrane was fabricated by dip-coating with DPVDF in Example 1 and then hydrophilic in the same manner as modification. The effect of the membrane fabricated in Example 1 on the clearance of bacteriophage PP7 virus was evaluated.

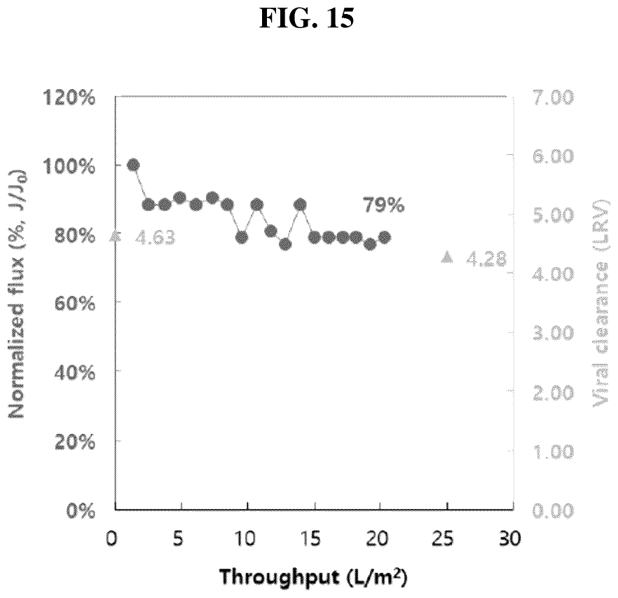

The virus used in Experimental Example 10 was bacteriophage PP7 virus (ca. 28 nm), and PBS was used as a buffer. In the experimental process of Experimental Example 10, a permeation experiment was conducted at a pressure of 1 bar, and the membrane was sufficiently washed with a buffer solution before the permeation experiment. The permeation experiment was conducted using a 10 mM PBS solution containing the PP7 Virus. The results of Experimental Example 10 are shown in Table 1 below and FIG. 15.

As a result of Experimental Example 10, it was confirmed that the log reduction value (LRV) of the membrane fabricated in Example 1 was 4.28 to 4.63, indicating a viral clearance rate of 99.99%.

TABLE 1
Starting Number = 1 million bacteria

| Log Reduction | % Reduction | Bacteria Remaining |
|---|---|---|
| 0 | 0% | 1,000,000 |
| 1 | 90% | 100,000 |
| 2 | 99% | 10,000 |
| 3 | 99.9% | 1,000 |
| 4 | 99.99% | 100 |
| 5 | 99.999% | 10 |

While the present disclosure has been described with reference to the particular illustrative embodiments, it will be understood by those skilled in the art that the present disclosure may be embodied in other specific forms without departing from the technical spirit or essential characteristics of the present disclosure. Therefore, the embodiments described above are considered to be illustrative in all respects and not restrictive.

What is claimed is:

1. A polymer membrane comprising a porous polymer substrate and a coating layer formed on at least one surface of the porous polymer substrate,
wherein the coating layer comprises: a double bond-containing polyvinylidene fluoride (DPVDF); and a polymer containing at least one amine group, or a monomer containing at least one amine group.

2. The polymer membrane of claim 1, wherein the porous polymer substrate comprises at least one selected from the group consisting of polyvinylidene fluoride (PVDF), polyvinylidene fluoride-hexafluoropropylene (PVDF-HFP), polysulfone (PSF), polypropylene (PP), polyethylene (PE), and cellulose acetate.

3. The polymer membrane of claim 1, wherein the polymer containing at least one amine group is at least one polymer selected from the group consisting of Jeffamine D-230, linear polyethyleneimine, branched polyethyleneimine (BPEI), polyacrylamide, and polyethylene glycol diamine.

4. The polymer membrane of claim 1, wherein the monomer containing at least one amine group is at least one monomer from the group consisting of Jeffamine EDR 148, selected ethylenediamine (EDA), triethylenetetramine (TETA), hexamethylenediamine (HMDA), 1,3-diaminopropane, and diethylenetriamine (DETA).

5. The polymer membrane of claim 1, wherein the polymer membrane is used for water treatment, a virus filter, a pretreatment system for a seawater desalination process, or a food purification system.

6. A method for fabricating a polymer membrane, comprising steps of:
dip-coating a porous polymer substrate with a double bond-containing polyvinylidene fluoride (DPVDF); and
modifying the dip-coated substrate to be hydrophilic by immersing the dip-coated substrate in a solution containing either a polymer containing at least one amine group or a monomer containing at least one amine group.

7. The method of claim 6, further comprising drying and rinsing steps.

8. The method of claim 6, wherein the porous polymer substrate comprises at least one selected from the group consisting of polyvinylidene fluoride (PVDF), polyvinylidene fluoride-hexafluoropropylene (PVDF-HFP), polysulfone (PSF), polypropylene (PP), polyethylene (PE), and cellulose acetate.

9. The method of claim 6, wherein the polymer containing at least one amine group is at least one polymer selected from the group consisting of Jeffamine D-230, linear polyethyleneimine, branched polyethyleneimine (BPEI), polyacrylamide, and polyethylene glycol diamine.

10. The method of claim 6, wherein the monomer containing at least one amine group is at least one monomer selected from the group consisting of Jeffamine EDR 148, ethylenediamine (EDA), triethylenetetramine (TETA), hexamethylenediamine (HMDA), 1,3-diaminopropane, and diethylenetriamine (DETA).

11. The method of claim 6, wherein the step of dip-coating the porous polymer substrate with the double bond-containing polyvinylidene fluoride (DPVDF) is a step of dip-coating the porous polymer substrate by immersion in a solution containing the DPVDF, wherein the solution containing the DPVDF is a solution obtained by adding the DPVDF at a concentration of 0.03 to 0.3 wt % to a mixed solvent of acetone and ethanol mixed at a weight ratio of 0.8 to 3:1.

12. The method of claim 6, wherein the solution containing either the polymer containing at least one amine group or the monomer containing at least one amine group is a solution containing branched polyethyleneimine (BPEI) at a concentration of 0.6 to 0.9 M.
